(19) United States
(12) Patent Application Publication
(10) Pub. No.: US 2006/0007697 A1
(43) Pub. Date: Jan. 12, 2006

(54) Front floodlight of a motor vehicle with adaptive light distribution

(75) Inventor: Ralf Ackermann, Kirchentellinsfurt (DE)

Correspondence Address: CENTRAL COAST PATENT AGENCY, PO BOX 187, AROMAS, CA, 95004, US

(73) Assignee: Automotive Lighting Reutlingen GmbH

(21) Appl. No.: 11/156,310

(22) Filed: Jun. 17, 2005

(30) Foreign Application Priority Data
Jul. 7, 2004 (DE) 10 2004 032 797.1

(51) Int. Cl. F21S 8/10; F21V 13/02

(52) U.S. Cl. 362/520; 362/512; 362/545

(57) ABSTRACT

Automobile headlight with adaptive light distribution to create various headlight modes, particularly light distribution of a high-beam, low-beam, driving light, and/or parking light, with a light source (1) and with an optical projection system (2) whereby the light source (1) is a field of individually-switchable LED's (3), and the optical projection system is a lens placed in front of the LED field and is shaped so that various light distributions may be created based on the headlight modes by means of targeted switching of individual areas of the LED field (3).

The invention relates to an automobile headlight with adaptive or variable light distribution to create various headlight modes based on the overall concept of Patent Claim 1.

Conventional automobile headlights possess conventional light bulbs, halogen light bulbs, or Xenon light bulbs as light sources. The headlights with halogen or Xenon light sources are characterized by stronger brightness with respect to conventional incandescent lamps. Like conventional headlight systems, they also possess expensive and large-volume reflectors and adjustment mechanisms in order to realize various headlight modes using a single headlight system. Thus, conventional headlights are characterized by the central positioning of a light source within a parabolic mirror, for example, and possibly with an optics system in front of it and with a dimmer to provide targeted and exact light distribution in front of the vehicle. Complex-shaped poly-elliptical reflectors have been recommended to create uniform light distribution in the desired areas that allow improved light distribution by means of a lens-shaped optics system (optical projection system) and a central light source, so-called PES headlights. The size of such headlights is considerable, and narrow limits are placed on the shape of the headlight and thereby the placement in the automobile body. Finally, the cost of such systems is considerable because of the complex design.

In contrast, it is the task of the invention to propose an automobile headlight that allows creation of various light distributions and headlight modes of simple design and with reduced volume requirement with respect to conventional headlights. The simple adaptation of the light distribution to various driving situations and/or vehicle types should also be easily realizable.

This task is solved by an automobile headlight with the properties of Patent Claim 1. Advantageous embodiments and expansions are the subject of the Dependent Claims.

Based on the invention, a headlight with adaptive light distribution will be presented to create various headlight modes, particularly light distribution of a high-beam, low-beam, driving light, and/or parking light, with a light source and a dedicated optical projection system whereby the light source is a field of individually-switchable LED's, and the optical projection system is a lens placed in front of the LED field and so shaped that various light distributions may be created based on the headlight modes by means of targeted switching of individual areas of the LED field. In this manner an extremely flat headlight may be realized that is essentially thin or two-dimensional. The headlight is suitable on the one hand to create different headlight modes in the form of various light distributions without adjustment mechanisms or similar. The flat positioning of individually-switchable light-emitting diodes (LED's) and an optical projection system adapted to the shape and size of the field alone allows the two-dimensional light source to be transferred directly onto the area in front of the vehicle. Also, the service life of the headlights is greatly increased with respect to conventional systems because of the use of a large number of individual LED's, and the current requirement is greatly reduced. The variation and adaptation of the light distribution to various driving situations may be accomplished simply and quickly in that the individually-switchable LED's are switched on or off as groups or areas.

In advantageous embodiment of the invention, the optical projection system positioned in front of the LED field is larger in two dimensions than the field itself. Any lateral scattering, even outside the LED field serving as the light source is accepted by the optics and projected onto the pre-defined area in front of the vehicle. Light-source use is thus optimized.

In another advantageous embodiment of the invention, the LED field serving as the light source possesses an elongated rectangular shape, and is mounted transverse to the vehicle's longitudinal axis. In this manner, the entire area in front of the vehicle may be adequately illuminated. A very wide or very narrow light distribution may advantageously be created in front of the vehicle using a relatively small headlight, e.g., for fog-light distribution. The elongated rectangular shape of the LED field, in conjunction with its optical projection system matched to it, corresponds to the very flat-far-reaching illumination field required by automobiles, and is thus specifically and particularly matched to the ratios of headlights. And finally, the headlights are smaller in height and depth than are conventional headlights.

In another advantageous embodiment of the invention, the optical projection system is a lens system that projects the entire LED field. The lens may, for example, be an elongated curved cylindrical lens that extends transverse to the vehicle's longitudinal axis. Other types of lens may be provided. For example, an oval cylindrical lens may alternatively be provided, or several lenses may be integrated into a projecting optical system. The essential thing for the invention is that an elongated rectangular light-source field may be projected two-dimensionally into the areas required by law as directly as possible.

In another advantageous embodiment of the invention, the individually-switchable LED groups are switched on or off by a control unit so that pre-determined areas of the projected illumination surface may be dimmed. In this manner, for example, the function of a dimmed (low-beam) light may be realized without an interposed dimmer. On the other hand, functions such as fog lamp or similar may be created using well defined bright-dark boundaries.

Alternatively, a mechanical dimmer may be provided that is mounted directly in front of the LED surface, and that may be pivoted into the generated light beam in a directed manner. The dimmer serves to create a sharp bright-dark boundary or additional fading of specific areas of the LED surface serving as the light source.

In another advantageous embodiment of the invention, the lens of the optical projection system for the headlight is integrated into a transparent headlight cover. The lens thus forms an outer area of the automobile body, and may be shaped to match design and construction requirements that are necessary within the scope of direct projection of the light coming from the LED surface.

Further advantages and properties of the invention are described in greater detail in the following, in which the invention is described in greater detail with reference to the embodiment example shown in the enclosed Illustration, which shows:

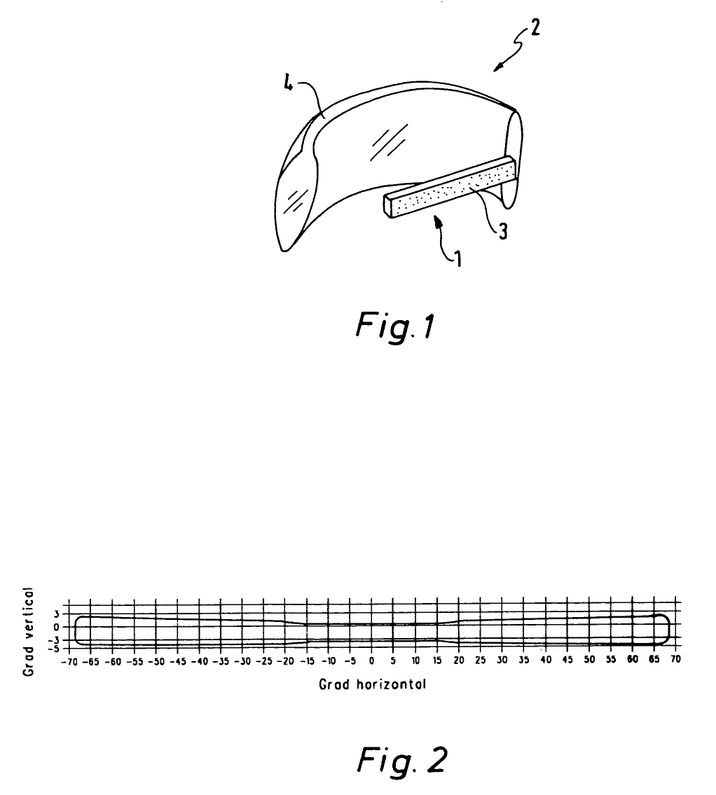

FIG. 1 schematic, oblique view of the essential elements of an embodiment example of a headlight based on the invention with rectangular LED field; and

FIG. 2 the light distribution in the horizontal and the vertical of a headlight system with two headlights each as in the embodiment example shown in FIG. 1.

In the embodiment example of the headlight based on the invention shown schematically in FIG. 1, basically only a two-dimensional light source 1 and an optical projection system 2 are provided. The light source 1 consists of a field of individually-switchable LED's 3. The individual LED's 3 are mounted in a elongated rectangular field that is positioned along a horizontal plane in the frontal area of an automobile (not shown). The quantity of LED's 3 and the size of the light source 1 formed from the LED field are so selected that adequate brightness and illumination is achieved in accordance with legal requirements for headlight systems. The optical projection system 2 in this embodiment example is a curved cylindrical lens 4 mounted at a distance from, and in front of, the LED surface 3. The shape and size of the cylindrical lens 4 is matched to the size of the LED field 3, and the type of light to be created by the headlight is determined, namely whether the headlight is mainly to be used to create a high-beam light, a low-beam light, a driving light, or a parking light. This shape of the cylindrical lens 4 of an elongated cylindrical lens curved about a vertical axis is particularly suited to create fog light distribution in the area in front of a vehicle. The optical projection system 2 may, however, possess other specific shapes in order, for example, to create an illuminating surface that corresponds to conventional low-beam light distribution. For this purpose, the two-dimensionally positioned LED's 3 of the light source 1 may be switched variously by means of a control unit (not shown). The LED's 3 may be individually switched, and may thus be switched in widely-varying groups, configurations, and distributions, also regarding light intensity. This allows, for example, creation of the illuminating surface for a low-beam light with the required 15° slant in that, for example, an upper row of otherwise unswitched LED's are switched on along with the others. Other headlight modes such as, for example, driving light, parking light, or similar may very simply be implemented in the same manner based on the invention. The headlights based on the invention are extremely compact and particularly flat since no space-consuming reflectors or adjustment mechanisms are required for adaptively-adjustable light distributions of the headlight. The illumination surface with its light source 1 consisting of a large number of individually-switched LED's 3 is also distinguished by low power consumption and long service life. The various modes of a headlight may be selected without moving, mechanical parts.

FIG. 2 shows a light distribution in the horizontals and the verticals that may be created by a headlight in accordance with a headlight based on the embodiment example of the invention shown in FIG. 1. Light distribution is shown here for a left and a right headlight based on the embodiment example of the invention shown in FIG. 1. One may clearly see the good reproduction of the shape of a rectangular, elongated LED field that is advantageously reflected in the light distribution. The problem with conventional headlights with a central light source (halogen, Xenon, or incandescent lamp) is that they have a clear-cut drop-off in light intensity in their edge areas. With the headlight based on the invention, the edge areas may be as fully and intensively illuminated as the central areas because of the two-dimensional feature the LED field has when used as the light source 1. FIG. 2 shows clearly a light distribution that is relatively wide, flat, and well limited at the edges. The dimensions and size of the headlights are reduced further, and the illumination of the area in front of the vehicle is increased, thus increasing safety.

All properties and elements shown in the Description, the following Claims, or the Figures are to be considered essential to the invention either individually or in any combination.

1. Automobile headlight with adaptive light distribution to create various headlight modes, particularly light distribution of a high-beam, low-beam, driving light, and/or parking light, with a light source (1) and with an optical projection system (2) characterized in that the light source (1) is a field of individually-switchable LED's (3), and the optical projection system is a lens placed in front of the LED field and so shaped that various light distributions may be created based on the headlight modes by means of targeted switching of individual areas of the LED field (3).

2. Automobile headlight as in claim 1, characterized in that the optical projection system (2) is larger in two dimensions, particularly larger than 1.5 times the size of the LED field (3) of the light source (1).

3. Automobile headlight as in claim 1 or 2, characterized in that the LED field (3) possesses an elongated rectangular shape and is positioned transverse to the vehicle's longitudinal axis.

4. Automobile headlight as in one of the prior claims, characterized in that the optical projection system (2) is a lens optical system (4) that projects the entire LED field (3).

5. Automobile headlight as in one of the prior claims, characterized in that the optical projection system (2) is a cylindrical lens (4) that is curved about a vertical axis and extends transverse to the vehicle's longitudinal axis.

6. Automobile headlight as in one of the prior claims, characterized in that the individually-switchable LED's (3) may be switched separately in groups by means of a control unit in such manner that pre-determined areas of the projected illumination surface are dimmed.

7. Automobile headlight as in claims 1 through 6, characterized in that a dimmer is provided that is mounted directly in front of the LED surface (3) and/or may be pivoted into the light beam created by the light source (1).

8. Automobile headlight as in one of the prior claims, characterized in that the lens (4) is shaped and integrated into a transparent cover of the headlight.
